(19) United States
(12) Patent Application Publication
(10) Pub. No.: US 2014/0151418 A1
(43) Pub. Date: Jun. 5, 2014

(54) VEHICLE-MOUNTED FIXING DEVICE FOR ELECTRONIC PRODUCT

(71) Applicant: Haiting YANG, Guangzhou (CN)

(72) Inventor: Haiting YANG, Guangzhou (CN)

(21) Appl. No.: 14/049,997

(22) Filed: Oct. 9, 2013

(30) Foreign Application Priority Data
Feb. 1, 2013 (CN) 201320058046.X

(51) Int. Cl. B60R 7/08

(52) U.S. Cl. CPC B60R 7/08
USPC 224/275

(57) ABSTRACT

A vehicle-mounted fixing device for an electronic product is disclosed, which includes a headrest positioning member detachably fixed onto a headrest, and an electronic product positioning member for fixing an electronic product, wherein the headrest positioning member and the electronic product positioning member are connected with each other and fixed together. The headrest positioning member may be mounted and detached when necessary, so it won't take up space inside the car when not in use; thereby a safety hazard is avoided.

### FIELD OF THE INVENTION

The present invention relates generally to the field of accessory for electronic product, and more particularly to a vehicle-mounted fixing device for an electronic product.

### BACKGROUND OF THE INVENTION

With the popularization of modern electronic products, such as tablet PCs, ultra-thin light weighted laptops, smart phones etc., people's daily lives become more colorful and more convenient. Wherever one goes, he/she can see application of these electronic products and enjoy the convenience they bring. Electronic products are always carried along, even when people are in the car; they can use electronic products to obtain information or for entertainment. As a result, a number of corresponding devices come into being, including these devices for supporting and fixing electronic products in the car, such as vehicle-mounted bracket for mounting electronic products, which facilitate the use of electronic products for rear passengers.

Traditional vehicle-mounted bracket are usually made of plastics, and are fixed by hooks and the like onto the mounting rod of the front seat headrest. The installation is complicated, and is not difficult to remove. In addition, the structure of the plastic supporting platform, which extends for supporting the electronic products thereon, has a high production cost. Meanwhile, since the plastic supporting platform is made of hard material, it is prone to be broken during drive. Also, sharp edges of the plastic supporting platform may have the risk of causing injure, especially during car bumps or braking. The large volume the plastic supporting platform takes up makes it inconvenient to carry, while it is neither neat nor safe when placed in a car.

Based on the above, there is a need to provide a vehicle-mounted fixing device for an electronic product, which is practical, simple, esthetic, safe, low-cost and durable, and is easy to mount or to detach.

### SUMMARY OF THE INVENTION

The aim of the present invention is to provide a detachable vehicle-mounted fixing device with simple structure for electronic product.

To achieve the purpose of the present invention, technical solutions are provided as follows.

The present invention provides a vehicle-mounted fixing device for an electronic product, which may include a headrest positioning member detachably fixed onto a headrest, and an electronic product positioning member for fixing an electronic product, wherein the headrest positioning member and the electronic product positioning member may be connected with each other and fixed together. The headrest positioning member may be mounted and detached when necessary, so it won't take up space inside the car when not in use; thereby a safety hazard is avoided.

In some embodiments, the headrest positioning member may include at least one strap, by which the vehicle-mounted fixing device for electronic product is fixed onto a headrest; this is simple in structure and is easy to be mounted and detached. The straps may be in various forms, such as elastic band, belt, cloth band, or made of other materials. In a preferred embodiment, the headrest positioning member may include two straps respectively fixed onto each side of the headrest, so as to allow the vehicle-mounted fixing device for electronic product to be fixed onto the headrest in a more stable and secure way. Nevertheless, the vehicle-mounted fixing device for electronic product may also be fixed onto the headrest stably and securely by only one strap. A more stable and secure mounting may be achieved by adjusting the position, width, and material of the straps.

In some embodiments, the at least one strap may be an elastic band constituting a circle, by which the vehicle-mounted fixing device for an electronic product can be fixed easily onto the headrest. This is simple in structure, easy to be mounted and detached, with low production cost and is safe and reliable. In a preferred embodiment, the headrest positioning member may includes two elastic bands respectively fixed to each side of the headrest, so as to allow the vehicle-mounted fixing device for an electronic product to be fixed onto the headrest in a more stable way.

In some embodiments, the at least one strap includes two sections, with one end of each section fixed onto the electronic product positioning member, and the other end provided with a complementary connecting member; the two sections may be connected to each other by the connecting members after the two sections going around the headrest. By this way, the headrest positioning member is fixed onto the headrest. This is simple in structure, easy to be mounted and detached, with low production cost, and is safe and reliable. In some embodiments, the connecting members may be buckles, Velcro, hooks, zippers, buttons or magnetic clasps, which is low-cost and is safe. In a preferred embodiment, the headrest positioning member may include two sections of straps as described above, each section respectively fixed onto one side of the headrest, so as to allow the vehicle-mounted fixing device for an electronic product to be fixed onto the headrest in a more stable way.

In some embodiments, the at least one strap may be fixedly connected to the electronic product positioning member, with both ends of the at least one strap provided with complementary connecting members. Generally, the electronic product positioning member may be fixed onto the middle section of the strap; two ends of the strap go around the headrest and are interconnected and fixed together by the connecting members, by which way the headrest positioning member is fixed onto the headrest. This is simple in structure, easy to be mounted and detached, with low production cost, and is safe and reliable. In some embodiments, the connecting members may be buckles, Velcro, hooks, zippers, buttons or magnetic clasps, which has lower production cost, and is safe.

In some embodiments, the at least one strap may be provided with a length-adjustable structure, which allows the mounting and detachment more flexible and convenient. Thus, it is adapted to different types and sizes of headrests, and is more practical.

The electronic product positioning member of the present invention may have a variety of embodiments and alternatives. In some embodiments, the electronic product positioning member may be Velcro or magnetic clasp provided on the straps, and those complementary Velcro or magnetic clasp provided on the back cover or protective casing of the electronic product. This is simple in structure, easy to be mounted and detached, with low production cost, and is safe and reliable. Electronic product may be fixed and removed conveniently, without any extra protruding structures in the device, which is space-saving, convenient and safe. The back cover or protective casing of electronic product may be made of soft rubber or other materials.

In some embodiments, the electronic product positioning member may be a vehicle-mounted bag provided with a receiving cavity, a display window, and an opening for putting electronic product into the bag. This vehicle-mounted bag has simple structure, and is safe and reliable. It is easy to fix an electronic product or to take it out, and can well protect the electronic product from being damaged.

In some embodiments, the vehicle-mounted bag may be provided with a speaker hole, keeping the sound effect of the electronic product unaffected.

In some embodiments, the vehicle-mounted bag is provided with a closure member, with one end of the closure member fixed to one side of the opening of the vehicle-mounted bag, and the other end of the closure member connected to the other side of the opening by Velcro, button or magnetic clasp. By this means, electronic product inside the vehicle-mounted bag is well fixed and protected, and is prevented from falling out of the bag or being damaged due to car bumps.

In some embodiments, the vehicle-mounted bag may be made of nylon or PU material, having good tenacity to well-protect electronic product inside it. Meanwhile, the vehicle-mounted bag itself is extremely light-weighted, and is dirt resistant and has long durable life. In addition, the vehicle-mounted bag may have soft inner lining, which can better fit the electronic product inside, and can protect the electronic product from being damaged.

In some embodiments, the opening is provided on the top end or side or front of the vehicle-mounted bag. This simple allows easy fixing and taking out of the electronic product.

Various embodiments of the headrest positioning member and the electronic product positioning member as described above may be combined with each, and the scope of the present invention should not be limited to the specific embodiments.

For example, in some embodiments, the headrest positioning member uses only one elastic band, by which the headrest positioning member is fixed onto the headrest. The electronic product positioning member may be Velcro or magnetic clasp provided on the elastic band, and those complementary Velcro or magnetic clasp provided on the back cover or protective casing of the electronic product; the electronic product positioning member may also be a vehicle-mounted bag fixed onto the elastic band.

In some embodiments, the headrest positioning member uses an elastic band, with both ends of the elastic band provided with complementary connecting members. The electronic product positioning member may be Velcro or magnetic clasp provided on the elastic band, and those complementary Velcro or magnetic clasp provided on the back cover or protective casing of the electronic product; the electronic product positioning member may also be a vehicle-mounted bag fixed onto the elastic band.

In some embodiments, the electronic product positioning member may be a vehicle-mounted bag, and the headrest positioning member may use two elastic bands fixed onto the vehicle-mounted bag. Alternatively, the headrest positioning member may use a strap fixed onto vehicle-mounted bag, and the strap may be consisted of two sections, with one end of each section respectively fixed onto the vehicle-mounted bag, and the other end provided with a complementary connecting member.

The vehicle-mounted fixing device for an electronic product may have more alternatives, and will not go into details here.

Compared with the prior art, the present invention has the following advantages.

The vehicle-mounted fixing device for an electronic product of the present invention includes a headrest positioning member detachably fixed onto a headrest, and an electronic product positioning member for fixing an electronic product; the headrest positioning member and the electronic product positioning member are connected and fixed together. The headrest positioning member may be mounted and detached when necessary, so it won't take up space inside the car when not in use and is safe and reliable, with the advantages of being practical, simple, neat, safe, low-cost and durable, and easy to mount or to detach.

### BRIEF DESCRIPTION OF THE DRAWINGS

FIG. 1 is a front schematic view of the first embodiment of the vehicle-mounted fixing device for an electronic product of the present invention;

FIG. 2 is a back schematic view of the first embodiment of the vehicle-mounted fixing device for an electronic product of the present invention;

FIG. 3 is a front schematic view of the second embodiment of the vehicle-mounted fixing device for an electronic product of the present invention;

FIG. 4 is a back schematic view of the second embodiment of the vehicle-mounted fixing device for an electronic product of the present invention;

FIG. 5 is a front schematic view of the third embodiment of the vehicle-mounted fixing device for an electronic product of the present invention;

FIG. 6 is a back schematic view of the third embodiment of the vehicle-mounted fixing device for an electronic product of the present invention.

### DETAILED DESCRIPTION OF THE PREFERRED EMBODIMENTS

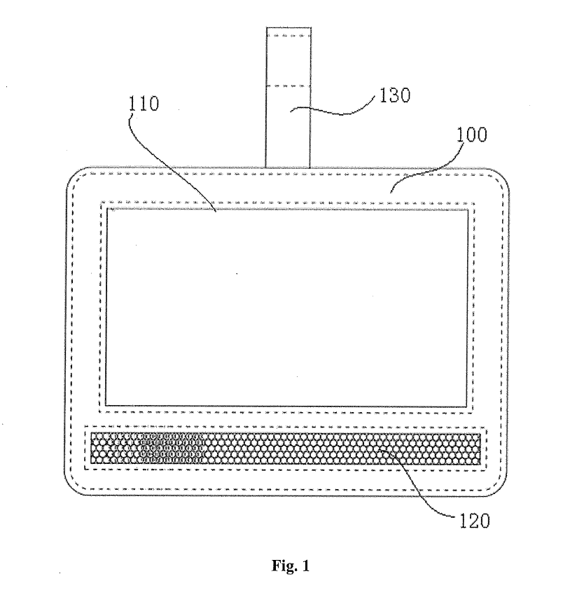

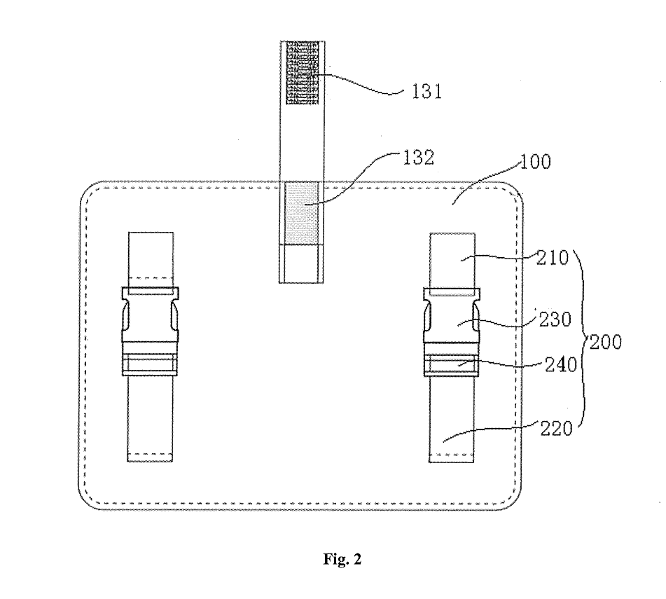

FIG. 1 and FIG. 2 illustrate the first embodiment of the vehicle-mounted fixing device for an electronic product of the present invention. The vehicle-mounted fixing device for an electronic product includes a vehicle-mounted bag 100 and two straps 200 detachable fixed onto the headrest. Each strap 200 consists of two sections: an upper strap 210 and a lower strap 220. One end of the upper strap 210 is fixed onto the back of the vehicle-mounted bag 100, while the other end of the upper strap 210 is provided with a male buckle 230; one end of the lower strap 220 is fixed onto the back of the vehicle-mounted bag 100, while the other end of the lower strap 220 is provided with a female buckle 240. When mounting, the upper strap 210 and the lower strap 220 respectively go around the headrest, and connect to each other by engaging the male buckle 230 and the female buckle 240. Thus, the vehicle-mounted fixing device for an electronic product is fixed onto the headrest in a simple way. For detaching, the user only has to repeat the above reversely.

In this embodiment, the upper strap 210 and the lower strap 220 are elastic bands, which are easy to operate, and are more adaptable and stable. Preferably, the straps are provided with elasticity adjusting buckle.

The vehicle-mounted bag 100 is provided with a display window 110, and a speaker hole 120. The sizes and positions of the display window 110 and the speaker hole 120 can be adjusted to accommodate different electronic products.

An opening is provided on the top end of the vehicle-mounted bag 100, with a closure member 130 provided in the opening. In this embodiment, the closure member 130 is a strip, with its one end fixed onto one side of the opening, and other end connected to the other side of the opening by complementary Velcro 131, 132. Thus, electronic product inside the vehicle-mounted bag is well fixed and protected, and is prevented from falling out of the bag or being damaged due to car bumps.

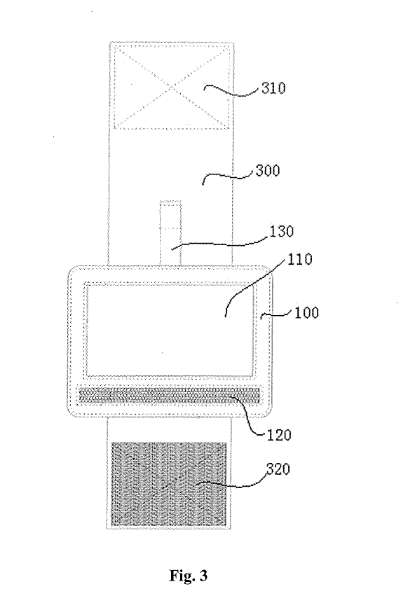

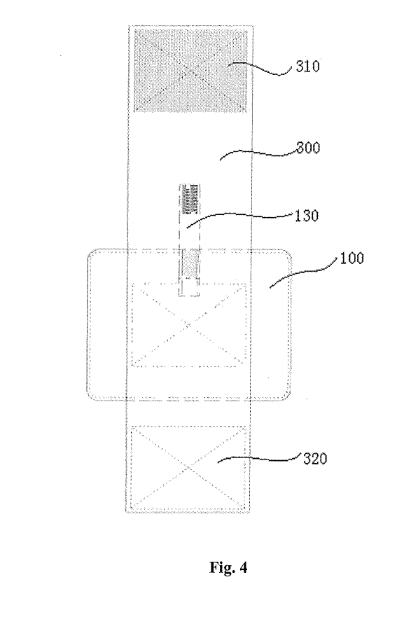

FIG. 3 and FIG. 4 illustrate the second embodiment of the vehicle-mounted fixing device for an electronic product of the present invention. The electronic product positioning member is a vehicle-mounted bag 100, same to that in the first embodiment. The difference is that the vehicle-mounted bag 100 of the second embodiment has a wider elastic band 300 fixed onto its back, with both ends of the elastic band 300 provided with a son Velcro 310 and a mother Velcro 320. When installing, both ends of the elastic band 300 respectively go around the headrest, and connect to each other by the son Velcro 310 and the mother Velcro 320. Thus, the vehicle-mounted fixing device for an electronic product is fixed onto the headrest in a simple way. For detaching, the user only has to repeat the above reversely.

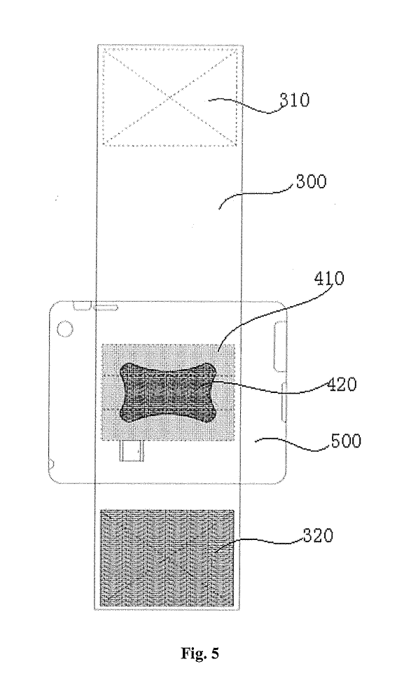

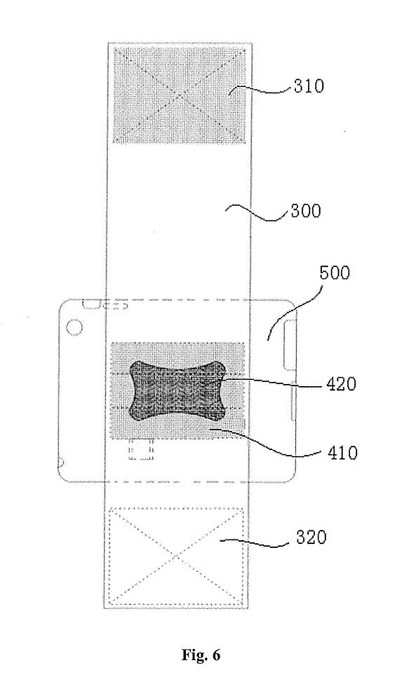

FIG. 5 and FIG. 6 illustrate the third embodiment of the vehicle-mounted fixing device for an electronic product of the present invention. The headrest positioning member is the same to that in the first embodiment and the second embodiment, using an elastic band 300 having complementary Velcros, i.e. son Velcro 310 and mother Velcro 320, at both ends. The difference is that the electronic product positioning member is a first Velcro 410 provided on the elastic band 300, and the second Velcro 420 provided on the back cover of the electronic product 500 which is complementary to the first Velcro 410. This simple structure makes it easy to fix the electronic product or to take it out, without any extra protruding structures, which is space-saving, convenient and safe. The back cover 500 of the electronic product is made of soft rubber. When mounting, both ends of the elastic band 300 respectively go around the headrest, and connect to each other by the son Velcro 310 and mother Velcro 320. An electronic product can also be fixed onto the back of the headrest by adherence of the second Velcro 420 on its back cover 500 and the first Velcro 410 on the elastic band 300; the detachment is also easy to operate.

The above are preferred embodiments of the invention, and the scope of the present invention is defined by the appended claims rather than the foregoing description and the exemplary embodiments described therein. Alternative embodiments will become apparent to those skilled in the art to which the present invention pertains without departing from its spirit and scope.

What is claimed is:

1. A vehicle-mounted fixing device for an electronic product, comprising:
a headrest positioning member detachably fixed onto a headrest, and
an electronic product positioning member, configured to fix an electronic product,
wherein the headrest positioning member and the electronic product positioning member are connected and fixed together.

2. The vehicle-mounted fixing device of claim 1, wherein the headrest positioning member comprises at least one strap.

3. The vehicle-mounted fixing device of claim 2, wherein the strap is an elastic band, which constitutes a circle.

4. The vehicle-mounted fixing device of claim 2, wherein the at least one strap comprises two sections; one end of each section is fixed onto the electronic product positioning member, and the other end of each section is provided with a complementary connecting member.

5. The vehicle-mounted fixing device of claim 4, wherein the connecting members are buckles, Velcro, hooks, zippers, buttons or magnetic clasps.

6. The vehicle-mounted fixing device of claim 2, wherein the at least one strap is fixedly connected to the electronic product positioning member, both ends of the strap are provided with connecting members cooperating to each other.

7. The vehicle-mounted fixing device of claim 6, wherein the connecting members are buckles, Velcro, hooks, zippers, buttons or magnetic clasps.

8. The vehicle-mounted fixing device of claim 7, wherein the electronic product positioning member comprises of Velcro or magnetic clasp provided on the straps, and the complementary Velcro or magnetic clasp provided on the back cover or protective casing of the electronic product.

9. The vehicle-mounted fixing device of claim 2, wherein the at least one strap is elastic band, belt, or cloth band.

10. The vehicle-mounted fixing device of claim 2, wherein the at least one strap is provided with a length-adjustable structure.

11. The vehicle-mounted fixing device of claim 1, wherein the electronic product positioning member is a vehicle-mounted bag comprising a receiving cavity for accommodating the electronic product, a display window, and an opening for putting electronic product into the bag.

12. The vehicle-mounted fixing device of claim 11, wherein the vehicle-mounted bag is provided with a speaker hole.

13. The vehicle-mounted fixing device of claim 11, wherein the vehicle-mounted bag is provided with a closure member; one end of the closure member is fixed to one side of the opening, and the other end of the closure member is connected to the other side of the opening by Velcro, button or magnetic clasp.

14. The vehicle-mounted fixing device of claim 11, wherein the at least one strap is elastic band, belt, or cloth band.

15. The vehicle-mounted fixing device of claim 11, wherein the at least one strap is provided with a length-adjustable structure.

16. The vehicle-mounted fixing device of claim 11, wherein the vehicle-mounted bag is made of nylon or PU material.

17. The vehicle-mounted fixing device of claim 11, wherein the opening is provided on the top end or side or front of the vehicle-mounted bag.
